(19) United States
(12) Patent Application Publication
(10) Pub. No.: US 2025/0256477 A1
(43) Pub. Date: Aug. 14, 2025

(54) Method And System For Forming Articles

(71) Applicant: Graphic Packaging International, LLC, Atlanta, GA (US)

(72) Inventors: Jeffrey T. Sloat, Broomfield, CO (US); Eric Bohn, Marathon, WI (US); Chris Baker, Thornton, CO (US)

(21) Appl. No.: 19/048,033

(22) Filed: Feb. 7, 2025

Related U.S. Application Data
(60) Provisional application No. 63/551,618, filed on Feb. 9, 2024.

(51) Int. Cl. B31B 50/14; B31B 50/59; B31B 50/74; B31B 120/20

(52) U.S. Cl. CPC B31B 50/142; B31B 50/592; B31B 50/741; B31B 2120/20

(57) ABSTRACT

A method or press-forming a construct. The method can comprise obtaining a forming tool comprising at least a punch and a cavity part. The cavity part at least partially defines a cavity and comprises a plurality of ports in fluid communication with the cavity. The method further includes positioning a moisturized paperboard packaging material between the punch and the cavity, and press-forming the moisturized paperboard packaging material into the construct by moving the punch and the cavity part together so that the punch is at least partially received in the cavity with the moisturized paperboard packaging material pressed therebetween. The method also includes removing moisturizing fluid in the cavity released by the moisturized paperboard packaging material during press-forming via the plurality of ports in the cavity part.

### CROSS-REFERENCED TO RELATED APPLICATIONS

This application claims the benefit of U.S. Provisional Patent Application No. 63/551,618, filed on Feb. 9, 2024.

### INCORPORATION BY REFERENCE

The disclosure of U.S. Provisional Patent Application No. 63/551,618, which was filed on Feb. 9, 2024, is hereby incorporated by reference for all purposes as if presented herein in its entirety.

### TECHNICAL FIELD

The present disclosure generally relates to packaging materials and systems and methods for making packaging materials. For example, the packaging material can include paperboard or other suitable materials and the systems and methods can include moistening the packaging material and forming the packaging material into containers and/or other suitable articles.

### BACKGROUND OF THE DISCLOSURE

Containers such as trays, bowls, etc. fold holding food products and/or other items can include features such as multiple compartments (e.g., having compartments of similar and/or different sizes and/or shapes), deep draws (e.g., bowl depths of greater than 2.5 inches (63.5 mm)), stiffening features (e.g., ribs), and/or other suitable features. Such containers may be made from molded plastic, for example. However, there is a desire to reduce or eliminate plastic in packaging in favor of more renewable and/or recyclable materials. For example, paper products (e.g., with a plastic barrier layer) can be used in packaging to significantly reduce the amount of plastic in the package or uncoated paperboard could be used to further reduce or eliminate the plastic from the packaging. Paper-based containers with features such as multiple compartments, deep draws, stiffening features, etc. can be made by molding a pulp into the shape of the container in examples. However, molded pulp processes tend to be expensive and slow.

### SUMMARY OF THE DISCLOSURE

In general, one aspect of the disclosure is directed to a method or press-forming a construct. The method can comprise obtaining a forming tool comprising at least a punch and a cavity part. The cavity part at least partially defines a cavity and comprises a plurality of ports in fluid communication with the cavity. The method further includes positioning a moisturized paperboard packaging material between the punch and the cavity, and press-forming the moisturized paperboard packaging material into the construct by moving the punch and the cavity part together so that the punch is at least partially received in the cavity with the moisturized paperboard packaging material pressed therebetween. The method also includes removing moisturizing fluid in the cavity released by the moisturized paperboard packaging material during press-forming via the plurality of ports in the cavity part.

In another aspect, the disclosure is generally directed to a forming tool for press-forming a construct. The forming tool can comprise a punch and a cavity part. The cavity part at least partially defines a cavity and comprises a plurality of ports in fluid communication with the cavity. The punch is for being at least partially received in the cavity for press-forming a moisturized paperboard packaging material into the construct between the punch and an interior surface of the cavity. The plurality of ports are for removing moisturizing fluid in the cavity released by the moisturized paperboard packaging material during press-forming.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure. The drawings are schematic and exemplary only and should not be construed as limiting the invention.

FIG. 1 is a schematic view of a system for forming a container or other suitable construct according to exemplary embodiments of the disclosure.

FIG. 2 is a schematic view of a packaging material treatment station of the system of FIG. 1 according to exemplary embodiments of the disclosure.

FIGS. 3A and 3B are schematic view of respective forming tools of a forming station of the system of FIG. 1 according to exemplary embodiments of the disclosure.

FIGS. 4A and 4B are schematic cross-sectional views of portions of respective packaging materials according to exemplary embodiments of the disclosure.

FIGS. 5 and 6 are perspective views of an exemplary forming tool according to exemplary embodiments of the disclosure.

FIG. 7 is a top plan view of a bottom assembly of the forming tool of FIGS. 5 and 6.

FIG. 8 is a cross-sectional view of the bottom assembly of FIG. 7 taken along line A-A.

FIG. 9 is a bottom perspective view of a cavity of the bottom assembly of FIGS. 7 and 8.

FIGS. 10A and 10B are perspective views of a bottom plate of the bottom assembly of FIGS. 7 and 8.

FIGS. 11A and 11B are top plan views of respective cavity inserts that can cooperate with the cavity of the bottom assembly according to exemplary embodiments of the disclosure.

FIG. 12 is a perspective view showing a cavity insert separated from the cavity according to exemplary embodiments of the disclosure.

Corresponding parts are designated by corresponding reference numbers throughout the drawings.

### DETAILED DESCRIPTION OF THE EXEMPLARY EMBODIMENTS

In embodiments the present disclosure provides systems and methods of forming a packaging material (e.g., in the form of a web or a blank) into a tray, carton, and/or other suitable container or construct for holding and/or packaging one or more articles. In exemplary embodiments, the packaging material can be formed into a construct for use in storing, transporting, displaying for sale, heating, eating, etc. one or more food items. The packaging material can comprise fibrous materials such as paper-based materials including paperboard (e.g., solid bleached sulfate paperboard), which can be uncoated or can be coated (e.g., with a barrier layer such as a polymer film or other suitable coating and/or laminated material).

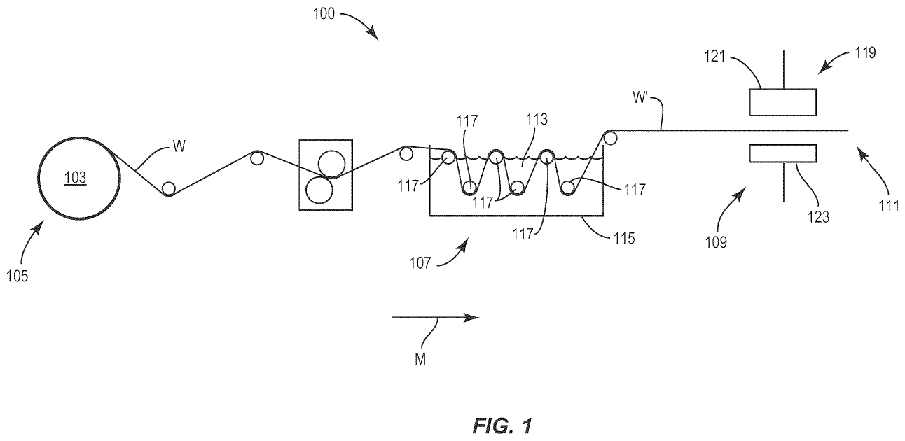

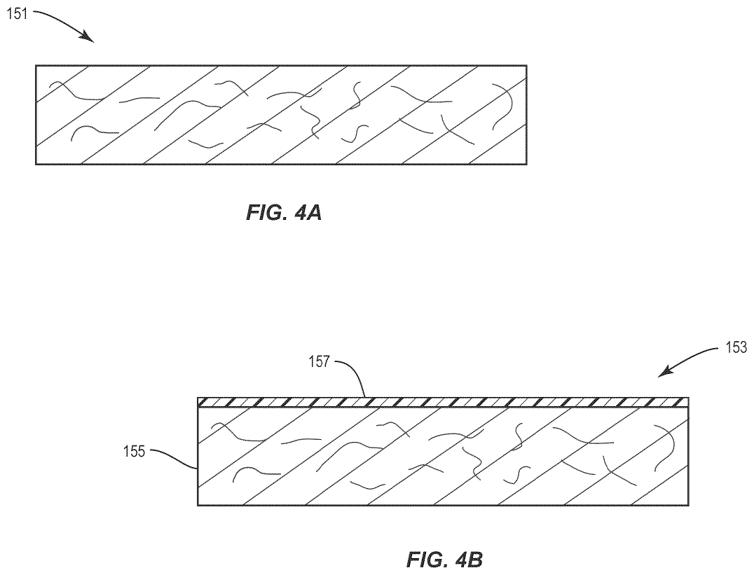

As schematically shown in FIG. 1, the method and system 100 can include feeding an initial packaging material, such as in the form of a web of material 101, in a downstream or machine direction M from a roll 103 at an upstream end 105 to a treatment station 107, then to a forming station 109, and to an output or downstream end 111. In embodiments, the system 100 can include a web transport system, which can include a plurality of drive rollers, guide rollers, nip rollers, and/or other suitable features for moving the web of material through the system 100. In other embodiments, the initial packaging material can be in the form of a plurality of blanks (not shown) that can be fed from the upstream end 105 (e.g., from a belt feeder or pick-and-place feeder and/or a conveyor or other suitable feeding and/or transport system). In exemplary embodiments, the initial packaging material (e.g., in the form of a web, a blank, and/or another suitable material) can be uncoated paperboard 151 (e.g., as schematically shown in cross-section in FIG. 4A) or can be a material 153 with a paperboard or other suitable substrate or base layer 155 and a barrier layer 157 on a face of the substrate 155 (e.g., as schematically shown in cross-section in FIG. 4B). In embodiments, the barrier layer 157 can be a coating or laminated layer, such as a polymer (e.g., PET) or other suitable material.

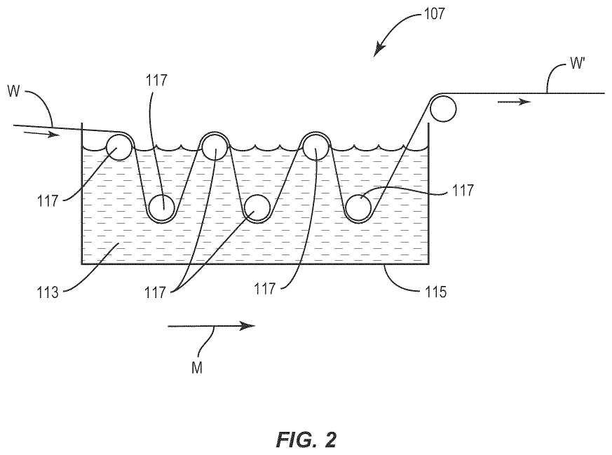

As shown in FIGS. 1 and 2, the treatment station 107 (e.g., an inline moistening unit/apparatus) can include a moisturizing liquid 113 in a vessel/tank 115. In embodiments, the moisturizing liquid 113 can be water or a water-based solution or mixture (e.g., water with surfactants and/or other materials) or another suitable moisturizing material (e.g., including water and/or other suitable liquids, solutes, mixtures, substances in suspension, etc.). In the illustrated embodiments, the web of material 101 can move over a plurality of rollers 117 (e.g., guide rollers and/or drive rollers) through the treatment station 107. As shown in FIGS. 1 and 2, the rollers 117 can be positioned so that each roller 117 is offset in the machine direction M and in the vertical direction from the previous roller 117 for moving the web of material 101 into and out of the moisturizing liquid 113 as the web of material 101 is moved through the treatment station 107. In other embodiments, the upper rollers 117 can be positioned in the moisturizing liquid 113 so that the web of material 101 remains in the moisturizing liquid 113 as the web of material 101 is moved through the moisturizing station 107. In exemplary embodiments, the length of the vessel 115, the number and positioning of the rollers 117, the depth of the moisturizing liquid 113 in the vessel 115, and/or other suitable parameters can be selected for achieving a desired dwell time of the web of material 101 for a particular processing speed of the system 100. In embodiments, increasing the dwell time of the web of material 101 in the moisturizing liquid 113 can increase the amount of the moisturizing liquid 113 absorbed by the web of material 101 and decreasing the dwell time can decrease the amount of moisturizing liquid 113 absorbed by the web of material 101. Other parameters may affect the amount of moisture that is absorbed by the web of material 101, such as the temperature of the moisturizing liquid 113 and/or the use of surfactants. For example, heat can be applied to the moisturizing liquid and/or surfactants can be included in the moisturizing liquid to increase water penetration into the material.

In embodiments in which the initial packaging material is in the form of a plurality of blanks (not shown), the blanks can be moved to the treatment station (e.g., on a conveyor or with a pick-and-place apparatus). One or more blanks can be positioned in the moisturizing liquid 113 for a predetermined dwell time. Subsequently, the blanks can be removed from the moisturizing liquid 113 and conveyed to the forming station 109. In alternative embodiments, one or more blanks can be moved through the moisturizing liquid 113, such as by a conveyor. The treatment station 107, including at least the moisturizing liquid 113, the vessel 115, and/or the rollers 117, could be otherwise shaped, arranged, positioned, and/or configured without departing from the disclosure.

In exemplary embodiments, the treatment station 107 can be configured to form an intermediate or treated packaging material, such as an intermediate or treated web W′ (e.g., a moisturized web) (FIG. 1) or a moisturized blank (not shown) with a predetermined moisture content (e.g., moisture absorbed by the fibers of the material). In embodiments, the material can be moisturized to a sufficient moisture content so that the treated packaging material can be press-formed into desired shape(s) while avoiding oversaturating the material (e.g., wherein one or more properties of the material degrade below a desired level, such as by failing a tensile test or by breaking apart in the moisturizing liquid 113). For example, the treated web W′ can include more than 10% by weight of the moisturizing liquid 113, between about 10% and about 50% by weight of the moisturizing liquid 113, between about 10% and about 20% by weight of the moisturizing liquid 113, between about 20% and about 30% by weight of the moisturizing liquid 113, between about 30% and about 40% by weight of the moisturizing liquid 113, between about 40% and about 50% by weight of the moisturizing liquid 113, between about 20% and about 50% by weight of the moisturizing liquid 113, between about 30% and about 50% by weight of the moisturizing liquid 113, between about 10% and about 40% by weight of the moisturizing liquid 113, between about 10% and about 30% by weight of the moisturizing liquid 113, between about 20% and about 40% by weight of the moisturizing liquid 113, and/or other suitable moisture contents.

As schematically shown in FIG. 1, the treated web W′ can move in the machine direction M from an output of the treatment station 107 to the forming station 109 (e.g., over rollers and/or other suitable conveying features). In other embodiments, the moisturized blank (not shown) can be conveyed from the treatment station 107 to the forming station 109. In embodiments, the forming station 109 can include a forming tool 119, such as a metal press-forming tool or other suitable tool. In exemplary embodiments, the forming tool 119 can be configured for forming a suitable construct, such as a tray (e.g., a tray having multiple compartments, straight sides, and/or curved corners), a bowl (e.g., a container with a deep draw, such as a bowl with a depth of greater than 2.5 inches (63.5 mm)), a container with stiffening features (e.g., ribs or other suitable features), and/or other suitable constructs. For example, the forming tool 119 can include a first (e.g., upper) part 121 and a second (e.g., lower) part 123 with corresponding features that can be pressed together to form the treated web of material W′ or the moisturized blank into the construct. In exemplary embodiments, the first part 121 and the second part 123 can include projections, protrusions, recesses, cavities, etc. that are complementary with respective cavities, recesses, protrusions, projections, etc. in the opposing tool part.

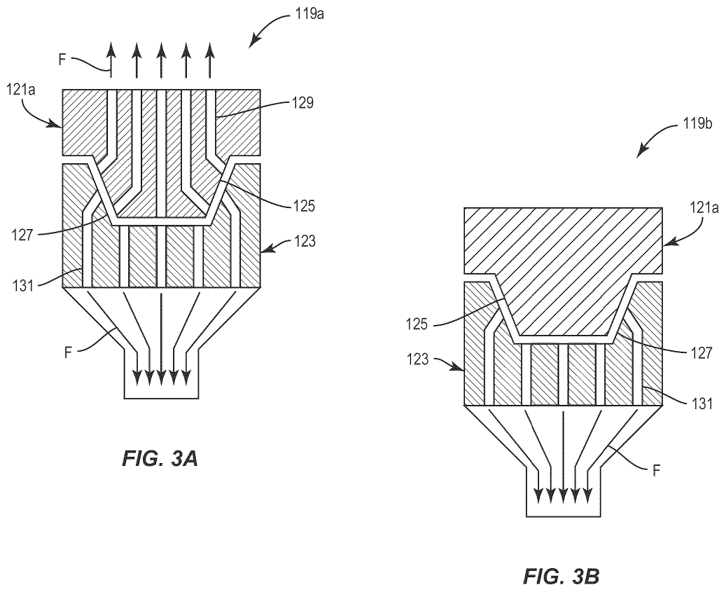

In an exemplary embodiment schematically shown in FIG. 3A, a forming tool 119a can be configured for press-forming a treated web of material W′ and/or a treated blank that does not include a barrier layer on either surface (e.g., uncoated paperboard 151 shown schematically in FIG. 4A). In the illustrated embodiments, the forming tool 119a includes a first part 121a with a projection 125 and a second part 123 with a cavity 127, wherein the cavity 127 and the projection 125 cooperate to press-form the uncoated treated web of material W′ and/or moisturized blank into a container (not shown). The cavity 127 and the projection 125 shown, schematically, in FIG. 3A are included by example only, and the first part 121a and the second part 123 could have any suitable forming features for forming any suitable construct.

As schematically shown in FIG. 3A, a plurality of ports 129 (e.g., first or upper ports 129) are formed in the first part 121a and a plurality of ports 131 (e.g., second or lower ports 131) are formed in the second part 123. In embodiments, the forming tool 119a can include any suitable number of ports 129, 131 (e.g., one or more ports). In the illustrated embodiments, the ports 129, 131 can provide pathways through the respective parts 121a, 123 of the forming tool 119a for communicating steam and/or other fluid(s) F at least partially through the respective parts 121a, 123. For example, the forming surfaces of the parts 121a, 123 (e.g., the surfaces that face, contact, and/or press against the treated web W′ and/or the treated blank) can be in fluid communication with a respective exhaust feature of the respective part 121a, 123. In embodiments, moisture and/or other fluids F from the moistened material (e.g., steam and/or other vapor formed from the moisturizing liquid due to the heat and/or pressure applied by the forming tool 119a) can be ventilated from the portion of the forming tool 119a between the parts 121a, 123 to respective exhaust features via the ports 129, 131. In embodiments, the ports 129, 131 can allow the fluids F to escape passively and/or vacuum pressure can be applied via the ports 129, 131 to draw the moisture through the ports 129, 131 away from the press-formed material.

In embodiments in which the treated web of material W′ or treated blank includes a barrier layer on one surface (e.g., packaging material 153 with the paperboard base layer 155 and the barrier layer 157), the ports in the part of the forming tool facing the barrier layer can be omitted. For example, as schematically shown in FIG. 3B, the forming tool 119b includes a first part 121b that does not have the ports 129. The forming tools 119a, 119b, including the parts 121a, 123, 121b could be otherwise shaped, arranged, positioned, and/or configured without departing from the disclosure. For example, the forming tools 119a, 119b could include any suitable forming features and/or any suitable number of ports 129, 131.

In the illustrated embodiments, the containers or other constructs formed in the forming station 109 can exit the forming station 109 and continue in the machine direction M for further processing (e.g., application of additional coatings and/or other treatments, lamination, etc.), covering, (e.g., application of a lid, film, overwrap, etc.), and/or other suitable operations. Accordingly, the treatment station 107 and the forming station 109 can be in line with other stations for finishing the construct. Further, in embodiments, the system 100 could include additional stations and/or apparatus and the packaging material and/or intermediate packaging material could undergo additional processing and/or forming operations before the treatment station 107 and/or between the treatment station 107 and the forming station 109.

In embodiments, moisturizing the web of material W and/or the blank to a high moisture content and press-forming the moisturized material with a forming tool having a plurality of ports for ventilating steam and/or other fluids F can have advantages over other embodiments. For example, in some embodiments, the web of material or blank is moisturized (e.g., in a laminator or other suitable device) to less than or equal to 10% moisture concentration to limit or avoid tearing, rupturing, and/or blow outs of the material caused by steam formation during press-forming when the steam has no outlet from the forming tool. Limiting the moisture content to less than 10% can limit the constructs formed from the material to fewer features (e.g., single compartment trays, constructs with two equal compartments, shallow containers, little or no stiffening features) (e.g., due to a relatively low malleability of the material with limited moisture content). In exemplary embodiments, porting the forming tool 119 in the forming station 109 can reduce or eliminate the risk of damage to the pressed material by ventilating and/or evacuating at least a portion of the steam formed from the moisturized material during pressing. Accordingly, the web of material W and/or blank can be moisturized in the treatment station 107 to have a moisture content of over 10%, which can allow the material to be formed into containers and/or other constructs with numerous features (e.g., stiffening features and/or multiple compartments of similar and/or different sizes and/or shapes) and/or with deeper draws (e.g., with depths of more than 2.5 inches (63.5 mm)). For example, the treated web W′ or treated blank with a moisture content of over 10% can be more malleable than materials with less moisture. In exemplary embodiments, the moistened material can be paperboard that may become a malleable “fluff pulp” type of material when moistened to a high moisture content. In embodiments, when moistened as described above, the material (e.g., paperboard) can have the capabilities (e.g., features) of containers and other constructs made from molded plastic or molded pulp with the speed and/or other advantages of paperboard systems that operate with paperboard in the form of webs and/or blanks.

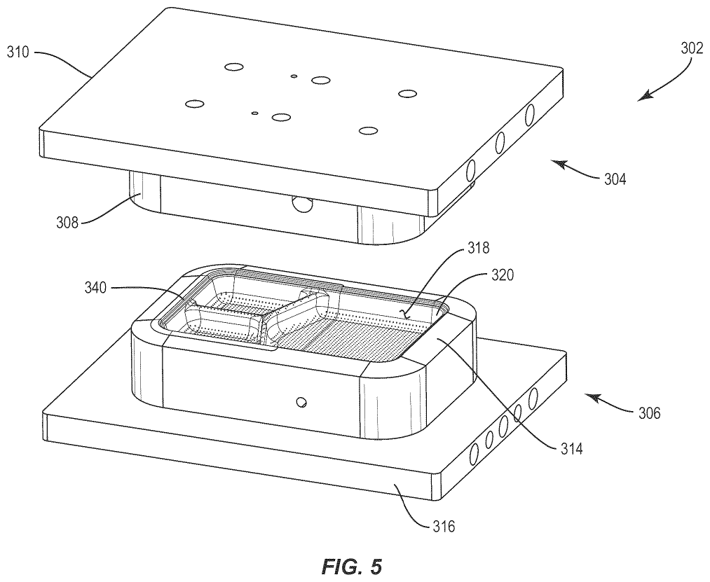

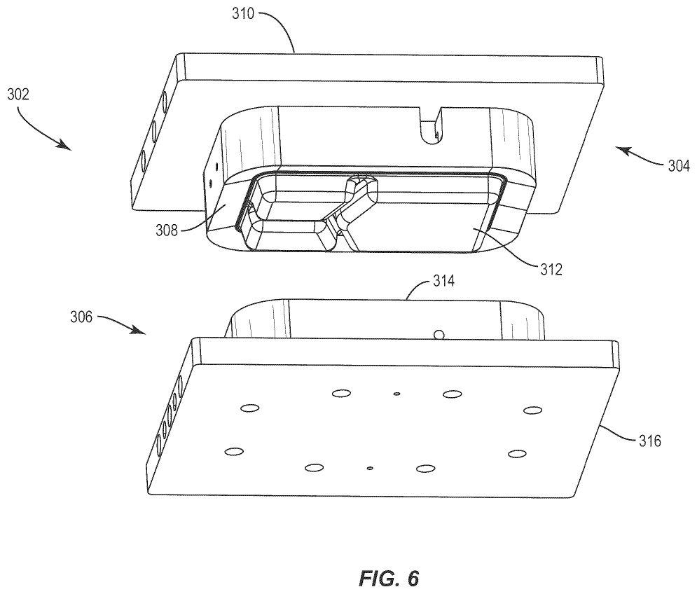

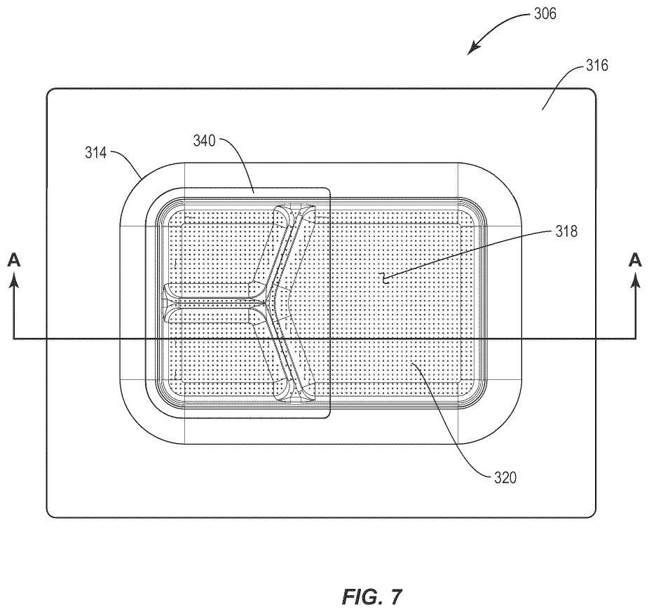

As shown in FIGS. 5 and 6, an exemplary forming tool 302 (e.g., for use in the forming station 109 of FIG. 1) can include a first or top assembly 304 and a second or bottom assembly 306 opposite to the assembly part 304. In the illustrated embodiments, the top assembly 304 can include a draw ring 308 mounted to a top mounting plate 310 and a protrusion or punch 312 at least partially received in an interior space of the draw ring 308. As shown in FIGS. 5 and 6, the bottom assembly 306 can include a cavity part 314 mounted to a bottom mounting plate 316. In embodiments, the cavity part 314 can define a cavity 318 opposite to the bottom mounting plate 316, and the cavity 318 can extend along an interior surface 320 of the cavity part 314 (FIGS. 5, 7, and 8). In the illustrated embodiments, the cavity 318 and the punch 312 can be complimentary shapes so that the punch 312 is at least partially received in the cavity 318 when pressing the packaging material into shape. For example, as shown in FIGS. 5 and 6, the punch 312 and the cavity 318 can be shaped to form a tray with three compartments. Alternatively, the punch 312 and the cavity 318 can have any suitable shape for forming any suitable container without departing from the disclosure.

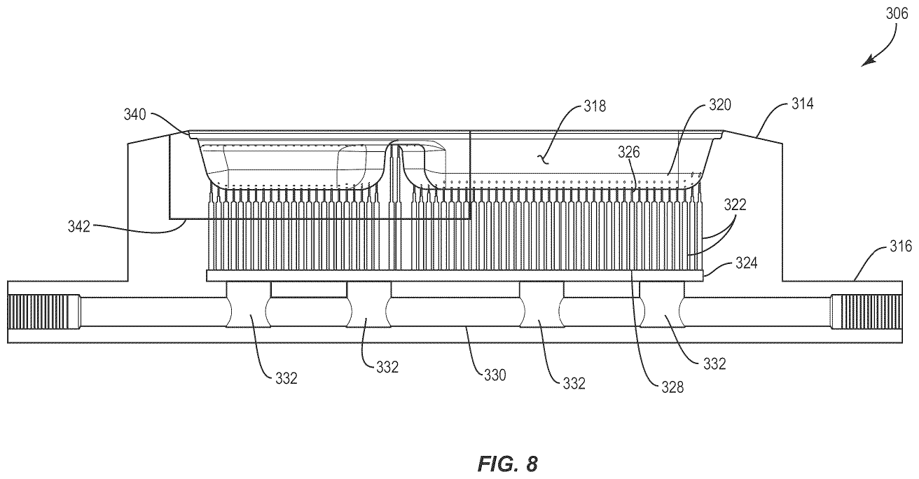

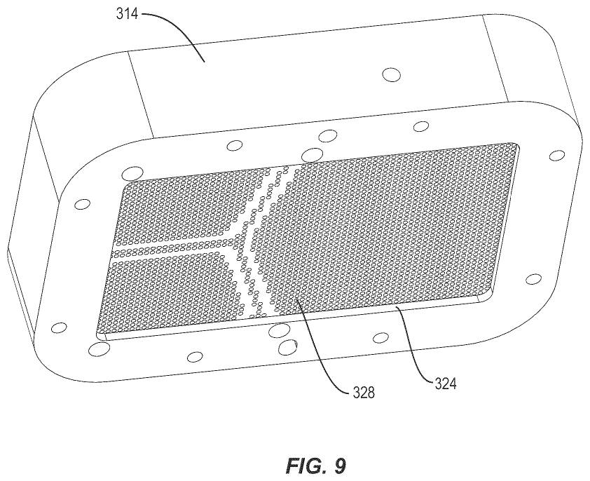

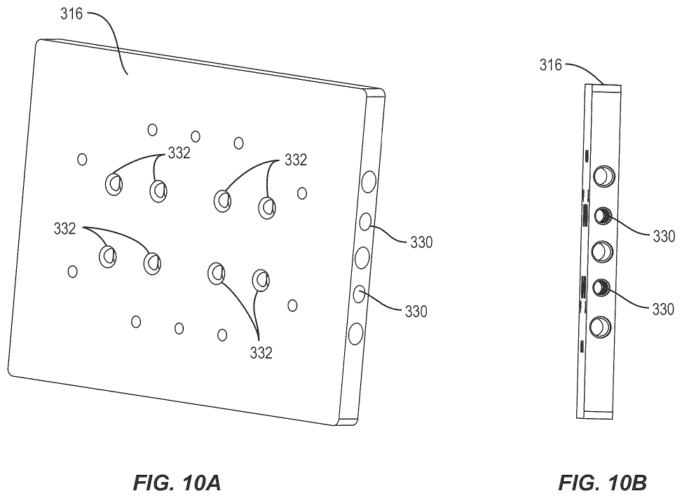

As shown in the cross-sectional view of FIG. 8, the bottom assembly 306 can include exhaust features for facilitating the movement of steam and/or other fluids F from the interior surface 320 of the cavity 318 (e.g., when press-forming a paperboard material with moistened with greater than 10 wt % moisturizing fluid). In exemplary embodiments, a plurality of ports 322 can extend through the cavity part 314 from the interior surface 320 of the cavity 318 to a bottom recess 324 defined in the bottom of the cavity part 314 (FIGS. 8 and 9). In the illustrated embodiments, each of the ports 322 can be in fluid communication with the cavity 318 via an inlet 326 and can be in fluid communication with the bottom recess 324 via an outlet 328. As shown in FIGS. 8, 10A, and 10B, the bottom mounting plate 316 can include two output passageways 330 in fluid communication with the bottom recess 324 of the cavity part 314 via openings 332 (e.g., via four openings 332 for each of the output passageways 330). Alternatively, the bottom mounting plate 316 could include any suitable number of output passageways 330 and any suitable number of openings 332. In embodiments, the ends of the output passageways 330 can be adapted to be coupled to hoses or pipes or other suitable fluid passages for moving the exhaust fluids F to a collection tank, for example. In embodiments, one or more of the ends of the passageways 330 can be connected to a vacuum apparatus (not shown) for aiding in the removal of the exhaust fluids F via the ports 322, the bottom recess 324, the openings 332, and the output passageways 330.

In the illustrated embodiments, the exhaust fluids F can move from the cavity 318 through the ports 322. The exhaust fluids F can move into the bottom recess 324 through the outlets 328 of the ports 322, and then can move into the openings 332 and through the output passageways 330. Accordingly, steam and/or other fluids F released from the moistened paperboard packaging material can be removed from the cavity 318 to help avoid blistering of a coating layer on the top surface of the packaging material, tearing of the packaging material, and/or other negative consequences of having steam and/or other fluids F trapped in the cavity 318 during press forming.

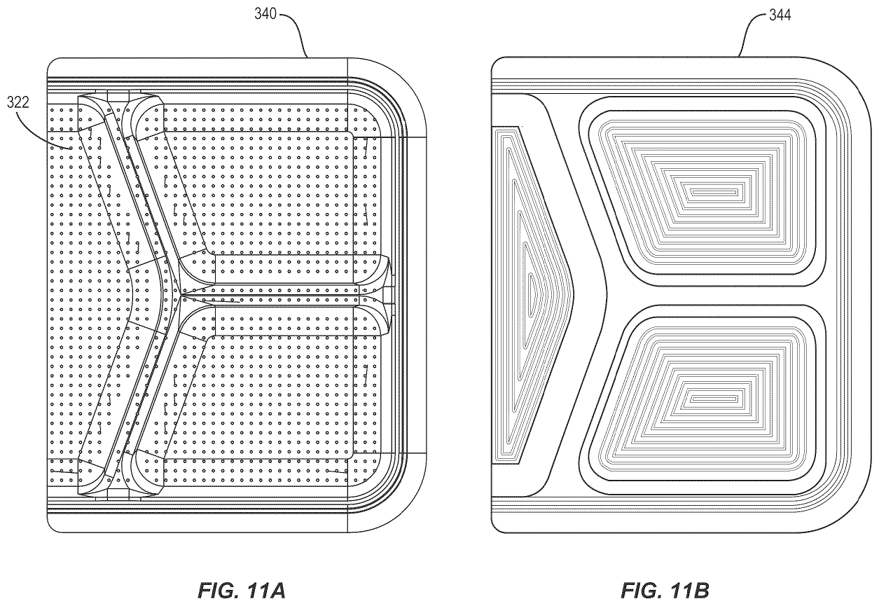

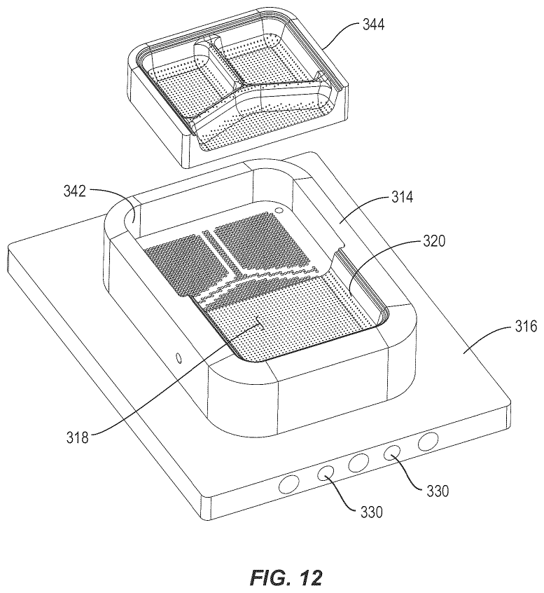

As shown in FIGS. 5, 7, and 8, a portion of the interior surface 320 of the cavity 318 can extend along an insert 340 FIGS. 5, 7, 8, and 11A) received in a pocket 342 (FIG. 12) defined in the cavity part 314. As shown in FIG. 8, the ports 322 aligned with the pocket 342 can continue through the insert 340 so that the portion of the interior surface 320 of the cavity 318 extending along the insert 340 is in fluid communication with the bottom recess 324 via the ports 322. In embodiments, the insert 340 can be replaced by an insert 344 (FIGS. 11B and 12), which does not include the ports 322 so that the portion of the interior surface 320 of the cavity 318 extending along the insert 340 is not in fluid communication with the bottom recess 324.

The forming tool 302 could be otherwise shaped, arranged, and/or configured without departing from the disclosure. For example, while the top assembly 304 lacks exhaust features as shown in FIGS. 5 and 6, an alternative top assembly 304 could include exhaust features such as ports in the punch and output passageways in the top mounting plate 310, which can be similar to the ports 322 and the output passageways 330 in the bottom assembly 306.

In operation, a moisturized paperboard packaging material can be move between the top assembly 304 and the bottom assembly 306, and the top assembly 304 and the bottom assembly 306 can be moved together (e.g., by moving one or both of the top assembly and the bottom assembly). As the top assembly 304 and the bottom assembly 306 are moved together, the punch 312 can move into the cavity 318, pressing the moisturized paperboard into the cavity 318. The punch 312 and the interior surface 320 of the cavity 318 press-form the moisturized paperboard into the shape of the construct according to the complimentary shapes of the punch 312 and the cavity 318. During this press-forming, steam and/or other fluids F can be released from the moisturized paperboard and can be vented out of the cavity 318 via the exhaust features (e.g., the ports 322, the recess 324, the openings 332, and the output passageways 330). Subsequently, the top assembly 304 and the bottom assembly 306 can be separated (e.g., by moving one or both of the top assembly and the bottom assembly), and the press-formed construct (not shown) can be removed from the tool 302.

The blanks according to the present disclosure can be, for example, formed from uncoated and/or coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method of press-forming a construct, the method comprising:
obtaining a forming tool comprising at least a punch and a cavity part, wherein the cavity part at least partially defines a cavity and comprises a plurality of ports in fluid communication with the cavity;
positioning a moisturized paperboard packaging material between the punch and the cavity;
press-forming the moisturized paperboard packaging material into the construct by moving the punch and the cavity part together so that the punch is at least partially received in the cavity with the moisturized paperboard packaging material pressed therebetween; and
removing moisturizing fluid in the cavity released by the moisturized paperboard packaging material during press-forming via the plurality of ports in the cavity part.

2. The method of claim 1, wherein the forming tool further comprises a bottom assembly, the bottom assembly comprises the cavity part and a bottom mounting plate, wherein the bottom mounting plate comprises one or more output passageways that are in fluid communication with one or more of the ports of the plurality of ports, and wherein the removing moisturizing fluid comprises moving the moisturizing fluid through the one or more output passageways away from the cavity part.

3. The method of claim 2, wherein the cavity part defines a bottom recess extending along the bottom mounting plate, the bottom recess being in fluid communication with the ports of the plurality of ports.

4. The method of claim 3, wherein the bottom recess of the cavity part is in fluid communication with the one or more output passageways via a plurality of openings in the bottom mounting plate.

5. The method of claim 1, wherein the moisturized paperboard packaging material includes more than 10% by weight of a moisturizing liquid prior to the press-forming the moisturized paperboard packaging material.

6. The method of claim 1, wherein the forming tool further comprises a top assembly comprising the punch, the moisturized paperboard packaging material comprises a barrier layer facing the punch, and the top assembly is free from exhaust features.

7. The method of claim 1, wherein the moisturized paperboard packaging material is uncoated, the punch comprises a plurality of top ports, and the removing moisturizing fluid in the cavity further comprises removing moisturizing fluid via the plurality of top ports in the punch.

8. A forming tool for press-forming a construct, the forming tool comprising:
a punch; and
a cavity part, wherein the cavity part at least partially defines a cavity and comprises a plurality of ports in fluid communication with the cavity;
wherein the punch is for being at least partially received in the cavity for press-forming a moisturized paperboard packaging material into the construct between the punch and an interior surface of the cavity, and wherein the plurality of ports are for removing moisturizing fluid in the cavity released by the moisturized paperboard packaging material during press-forming.

9. The forming tool of claim 8, further comprising a bottom assembly, wherein the bottom assembly comprises the cavity part and a bottom mounting plate, the bottom mounting plate comprises one or more output passageways that are in fluid communication with one or more of the ports of the plurality of ports, and the one or more output passageways are for further moving moisturizing fluid away from the cavity part.

10. The forming tool of claim 9, wherein the cavity part defines a bottom recess extending along the bottom mounting plate, the bottom recess being in fluid communication with the ports of the plurality of ports.

11. The forming tool of claim 10, wherein the bottom recess of the cavity part is in fluid communication with the one or more output passageways via a plurality of openings in the bottom mounting plate.

12. The forming tool of claim 8, wherein the moisturized paperboard packaging material includes more than 10% by weight of a moisturizing liquid prior to press-forming the moisturized paperboard packaging material.

13. The forming tool of claim 8, further comprising a top assembly comprising the punch, the moisturized paperboard packaging material comprises a barrier layer that is for facing the punch, and the top assembly is free from exhaust features.

14. The forming tool of claim 8, wherein the moisturized paperboard packaging material is uncoated, and the punch comprises a plurality of top ports for removing moisturizing fluid in the cavity released by the moisturized paperboard packaging material during press-forming.

15. The forming tool of claim 8, wherein the cavity part comprises a pocket and an insert is at least partially received in the pocket, and wherein the cavity extends along at least a portion of the insert when the insert is at least partially received in the pocket.
